(19) United States
(12) Patent Application Publication
(10) Pub. No.: US 2007/0021993 A1
(43) Pub. Date: Jan. 25, 2007

(54) Method and system for constructing, managing and using enterprise architecture in a component busines model

(76) Inventors: Ankur Chandra, Saratoga, CA (US); David L. Cohn, Dobbs Ferry, NY (US); David Bernard Flaxer, Dobbs Ferry, NY (US); Anil Nigam, Stamford, CT (US); Guy Jonathan James Rackham, New York, NY (US); Jorge L. Sanz, Pebble Beach, CA (US); John George Vergo, Yorktown Heights, NY (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 11/186,928

(22) Filed: Jul. 22, 2005

(51) Int. Cl. G06F 17/50

(52) U.S. Cl. 705/7

(57) ABSTRACT

A method and system is described for an enterprise architecture being viewed through a component business model of an organization, where the artifacts of the enterprise architecture are mapped to corresponding elements of the component business model. A metamodel is used to integrate a model of the enterprise architecture with the component business model. Views of the enterprise architecture are coupled to the layers of a component business model stack.

This invention is related to commonly owned patent application Ser. No. 11/______ for “SYSTEM AND METHOD FOR ALIGNMENT OF AN ENTERPRISE TO A COMPONENT BUSINESS MODEL” which is incorporated by reference herein.

### BACKGROUND OF THE INVENTION

1. Field of the Invention

The present invention generally relates to component based business models and, more particularly, to techniques for using enterprise architecture in a component business model.

2. Background Description

The Component Business Model (CBM) is an aggregation of models, methods and techniques that are designed to achieve the purposes of organizing, understanding, evaluating and ultimately, transforming an enterprise. The decomposition of an enterprise into well bounded and discrete business components enables a straightforward understanding of a complex enterprise and facilitates using information technology to realize business intent. The CBM model is more fully described in the above referenced U.S. patent application Ser. No. 11/______ for “SYSTEM AND METHOD FOR ALIGNMENT OF AN ENTERPRISE TO A COMPONENT BUSINESS MODEL” (hereafter referred to as “the above referenced foundation patent application”).

An Enterprise Architecture (EA) is an organization's framework of technology hardware, software, and related policies and business activities. It establishes a model of the organization and its business and IT operations. Akin to a city planning map which defines the standards for road, blocks, use, utility requirements, etc., an EA lays out the rules, standards, and basic design elements that the business technology must subscribe to. Further, it provides organizations with a systematic approach to aligning IT projects with corporate goals and priorities. An EA expresses a coordinating and organizing framework that enables the organization structure, business functions and processes to collaborate in achieving the goals of the enterprise.

Enterprise Architecture is a long established technique for representing various views and models of the enterprise. In general, an Enterprise Architecture can be decomposed into a series of views each addressing a specific aspect of the business such as: a technology view (covering computer infrastructure), a systems view (covering computer programs), an operations view (covering business processes), an architecture view (covering the overall framework of the EA), or any other view of the enterprise that is narrowed by a filtering logic and supported by one or more artifacts. The filtering logic options are those known in the enterprise architecture art or similar thereto, and the artifact convention is applied in this application to provide a concrete handle for the definition of the term “enterprise architecture” (EA). Further decompositions of these views into fine grained groups may be implemented as required by the EA architects and designers. Enterprise views are composed of one or more artifacts that represent an instance of the view.

An enterprise architecture can be very large and difficult to understand and use. This is especially true for large enterprises where the business organization is complex, the business operations require support from thousands of processes, and where the technology is distributed, multilayered and diverse. If properly used, an enterprise architecture facilitates business transformation by enforcing on the corporation a uniform set of standards, requirements and parameters for technology infrastructure. However, for an enterprise architecture to be successful it must be understandable, useful, and it must be followed by the business and IT areas of the corporation.

Identifying and organizing key elements of the enterprise architecture and organizing them into a usable and understandable structure within the context of a perspective useful to the user is a significant challenge. Should an enterprise architecture not be subscribed to and supported by the members of the corporation the result can be an ad-hoc, unstructured, uncoordinated business in which IT transformation decisions and management will be characterized by wasted resources, sub-optimized or incomplete plans and a perpetuation of the status-quo. Failure to support the EA can result in massive complexity, redundancy, inefficiency, the inability for the business to meet strategic business objectives.

In summary, if the problems describe above are not solved:
The Enterprise Architecture won't be used effectively.
Users will have difficulty accessing the EA.
Users won't understand the architecture.
Users won't be able to plan, execute and manage business transformations and corresponding transition plans.
Executives will be less able to tie strategic objectives to specific courses of action.
It will be harder for a business to: implement efficient, effective business processes;
provide accurate, reliable, timely information for decision making; and eliminate system duplication.

### SUMMARY OF THE INVENTION

It is therefore an object of the present invention to provide a complete view of the enterprise architecture at a level of granularity appropriate for each user in a range of user roles including executives, business architects, IT architects, and project managers.

It is another object of the invention to enable the creation, modification and validation of the enterprise architecture, including information and models that affect its structure and content.

A further object of the invention is to enable an overall organizing and integrating framework for the enterprise architecture, providing a strong, central representation of the enterprise for use in all phases of business transformation.

Yet another object of the invention is to facilitate easy access to the enterprise architecture, improving its usability by using the CBM model to provide enterprise architecture information in context, thus facilitating the creation, modification and use of enterprise architecture.

It is also an object of the invention to support enterprise architecture in large complex corporate environments, where business is federated into conglomerate corporate structures, and where business acquisitions, spin-offs and outsourcing are prevalent.

Yet a related object of the invention is to support enterprise architecture in small and medium sized businesses with relatively flat organizational structures.

The invention solves the above described problems by using the component business model to serve as an organizing framework in which to view the enterprise. CBM provides a logical and comprehensive view of the enterprise, in terms that cut across commercial enterprises in general and industries in particular. The component business model as described in the above referenced foundation patent application is based upon a logical partitioning of business activities into non-overlapping managing concepts, each managing concept being active at the three levels of management accountability: providing direction to the business, controlling how the business operates, and executing the operations of the business. The term “managing concept” is specially defined as described in the above referenced foundation patent application, and is not literally a “managing concept” as that phrase would be understood in the art. For the purpose of the present invention, as for the related invention, “managing concept” is the term associated with the following aspects of the partitioning methodology. First, the methodology is a partitioning methodology. The idea is to begin with a whole and partition the whole into necessarily non-overlapping parts. Second, experience has shown that the partitioning process works best when addressed to an asset of the business. The asset can be further described by attributes. Third, the managing concept must include mechanisms for doing something commercially useful with the asset. For a sensibly defined managing concept these mechanisms must cover the full range of management accountability levels (i.e. direct, control and execute). Managing concepts are further partitioned into components, which are cohesive groups of activities. The boundaries of a component usually fall within a single management accountability level. It is important for the utility of the CBM model to emphasize that the boundaries between managing concepts (and between components within managing concepts) are logical rather than physical.

CBM provides an organizational construct in which disparate pieces of information about the technology of the enterprise can be organized, partitioned and viewed. Information about the technology embodied in an enterprise architecture can originate from various sources, including management applications, monitors, databases and human roles. By viewing an enterprise architecture through the lens of a CBM map a context and organizing perspective is provided for the user, thus facilitating the understanding and use of the EA. Thus, where an existing enterprise architecture is established within the business, a CBM map can be used to more effectively view, understand and utilize the existing enterprise architecture.

The CBM model inherently possesses information about the business architecture and technology architecture of the enterprise. In the case where an enterprise architecture does not exist, through the use of analysis and analytic functions within CBM, an initial enterprise architecture may be defined and populated with information obtained for the enterprise, and the EA is coupled to the CBM organizational construct. Further, CBM provides a means of modifying and verifying an enterprise architecture. CBM provides the specification of a graphical user interface that exposes enterprise architecture information within context, which facilitates interaction with various user roles. The invention also enhances CBM by incorporating EA to support analytic techniques within CBM. Just as EA artifacts mapped to CBM components can be used from within the CBM application to point to these artifacts within the EA application, EA artifacts within the EA application can be used to point to the CBM components within a CBM application.

The invention establishes a means for mapping an existing enterprise architecture into a CBM model. It establishes a means for creating an enterprise architecture, where one does not exist, from a component business model. It establishes a means for modifying an existing enterprise architecture from a component business model. It also establishes a means for verifying an existing enterprise architecture from a component business model. It further provides a means of integrating disparate information about the enterprise (such as IT systems, business rules, and facilities) stored in databases, applications and agents, organized within a CBM framework, which is subsequently populated into the enterprise architecture. It establishes a means for accessing (viewing and using) enterprise architecture information through an organizing framework based on the component business model. It establishes a means for filtering enterprise architecture information within the context of a selected CBM element, i.e. business components, business operations (also known as “internal business processes” or “business processes”), business activities, business services and business competencies/accountability levels (as these terms are defined in the above referenced foundation patent application).

The invention establishes a means for filtering enterprise architecture information within the context of a user role. User roles refer to executives, business architects, IT architects, project managers and others. The invention establishes a metamodel that integrates an enterprise architecture model of the organization with the organization's component business model. This metamodel supports the creation, exchange and modification of information. The invention expresses a method that supports the coupling of an enterprise architecture and a component business model for the purpose of information integration, creation, modification and viewing. It enables presentation of the enterprise architecture based on the organizing framework of a CBM map of the enterprise, providing information and reports in context of CBM elements and user roles. The invention describes a new user interface that provides graphic views or reports enterprise architecture artifices based on the CBM map of the enterprise.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a schematic showing a CBM component map as a lens to view enterprise architecture artifacts in context.

FIG. 2 is a diagram showing the content of information in a component being used as a lens as in FIG. 1.

FIG. 3 is a flow chart showing a method of the invention.

FIG. 4 is a diagram showing a metamodel linking the component business model and enterprise architecture.

FIG. 5 is a process schematic showing how CBM is used to generate an enterprise architecture.

FIG. 6 is a diagram showing a system architecture supporting a CBM lens for enterprise architecture and creation and verification functions for enterprise architecture.

FIG. 7 is a mockup of an interface showing an implementation of the invention highlighting detail for a component.

FIG. 8 is a mockup of an interface showing an implementation of the invention highlighting enterprise architecture artifacts mapped to a component.

FIG. 9 is a mockup of an interface showing an implementation of the invention highlighting a process overlay upon a component map.

FIG. 10 is a schematic showing a coupling between the CBM stack and views of the enterprise architecture.

### DETAILED DESCRIPTION OF A PREFERRED EMBODIMENT OF THE INVENTION

The component business model (CBM) provides a framework for viewing the business in terms of components arrayed by competencies and by level of management accountability. Furthermore, these elements of a CBM model (components, competencies and management levels) also serve as the business layer which is supported by an applications layer, a linking communications layer, and an underlying technology layer of the business. These layers form what is called the “CBM stack,” which provides a graphical representation connecting respective portions of these layers. The supporting layers of technology, communications and applications are mapped to associated elements in the business layer, and the elements of the business layer therefore provide a window through which the respective portions of the supporting layers may be viewed.

The component business model provides a natural foundation for an improved enterprise architecture. In the first place, the elements of the business layer (i.e. the various partitions of the component map) provide a comprehensive index for organizing the elements of the enterprise architecture, as will be explained below. Second, the layers of the CBM stack show that enterprise architecture is implicitly a part of the CBM model: a business architecture, a system (applications) architecture, and a technology (infrastructure) architecture correspond, respectively, to the business layer, the applications layer and the technology layer of the CBM stack. Each of these architectures comprise artifacts that define or describe rules that apply to the respective architectures. For example, artifacts describing business rules and policies applicable to the business layer provide the content of a business architecture; artifacts describing rules and policies applicable to applications provide the content of an architecture covering the applications layer; and artifacts describing rules and policies for the communications and technology infrastructure provide the content of a technology architecture.

Use of the component business model for an improved enterprise architecture is useful for the simple and straightforward organizations of the small and medium sized businesses with relatively flat organizations and structures, as well as for the complex, federated and conglomerate enterprises discussed in greater detail below.

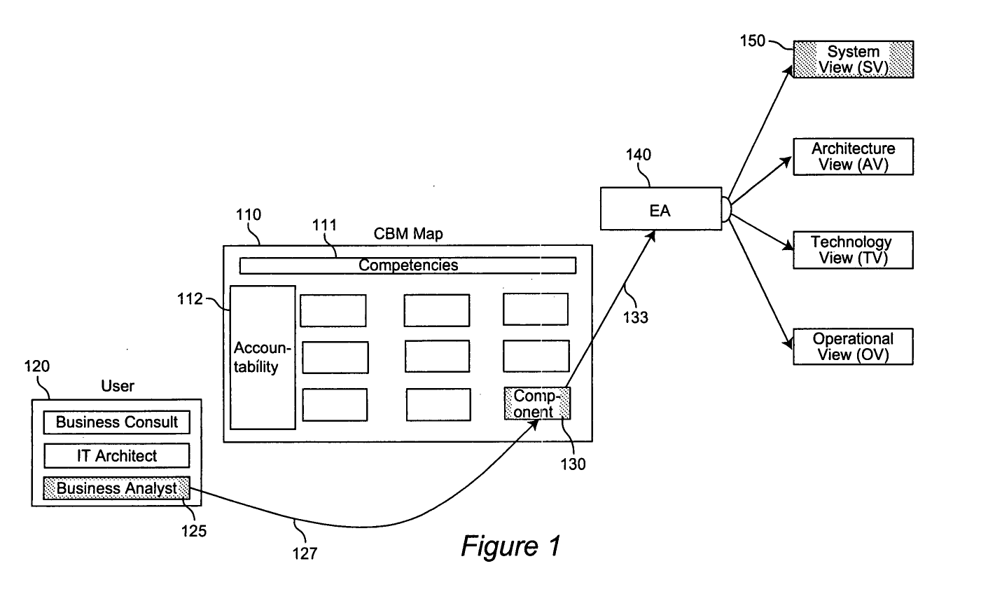

The use of a component business model as a lens into enterprise architecture may be understood with reference to FIG. 1. In the prior art, without a CBM model, a user 120 of an enterprise architecture 140 would access artifacts of the enterprise architecture through a view (e.g. system view 150). While a view is complete with respect to some aspect of the enterprise architecture (e.g. system view 150) a typical user (e.g. a business analyst 125) will be interested in only a part of the complete view. A CBM map 110 provides an organization of the business into components arranged by competency 111 and, within a competency 111, further arranged by the level of management accountability 112. CBM is able to present a complex business enterprise in an understandable and well organized view. This CBM partitioning of the business enables the typical EA user (e.g. business analyst 125) to select 127 a narrower set of business activities (represented by a component 130 or even a competency 111) aligned with the user's focus. By mapping the enterprise architecture 140 onto the CBM map 110, as explained below, a user 120 is able to view 133 those portions of the enterprise architecture 140 mapped to the user's selected set of business activities, as represented by a component (e.g. 130).

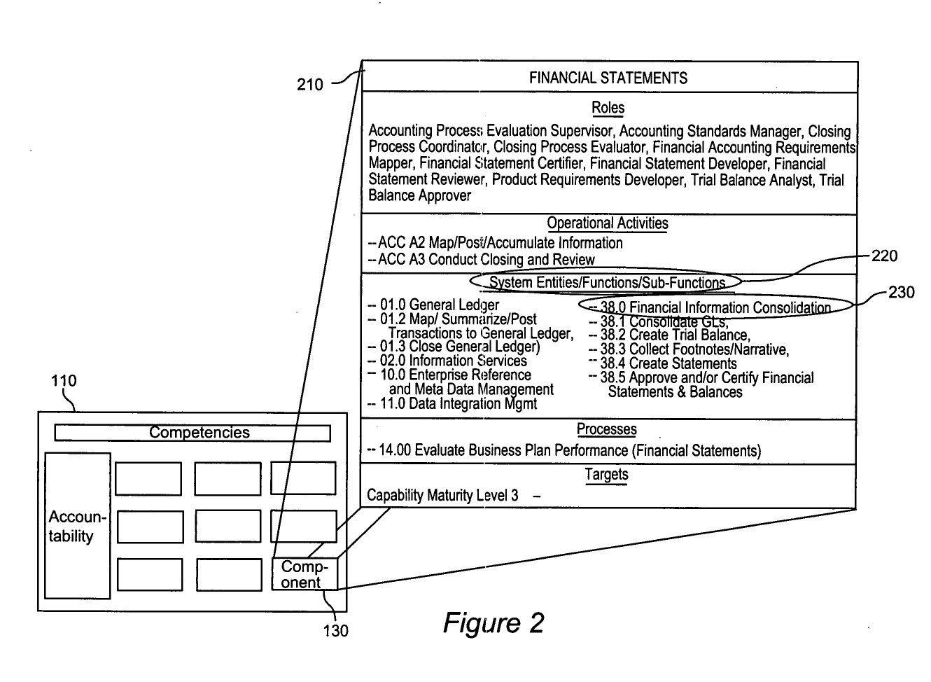

The mapping to the CBM framework serves to localize and encapsulate related EA artifacts. As a consequence of coupling CBM to the EA, the visualization and evaluation features of CBM are extended to the EA. This brings clarity to the EA information by bringing related EA information together within the context of a CBM structure, such as a component or competency. The related EA information 210 is shown in FIG. 2. Each element of EA information 210 is a summary and pointer to an EA artifact. Each artifact contains a rule or policy governing the use of technology by the business. For example, within the “Systems Entities/Functions/Sub-Functions” grouping 220 within the “Financial Statements” EA information 210, the item “Financial Information Consolidation” 230 is a pointer to an EA artifact describing the rules and policies of the enterprise that must be followed in order that financial information is appropriately consolidated to serve the operational and strategic interests of the enterprise. For example, the artifact associated with the “Financial Information Consolidation” pointer 230 may require that all financial information contain certain minimum fields each meeting a particular definitional requirement so that the information can be consolidated across the enterprise.

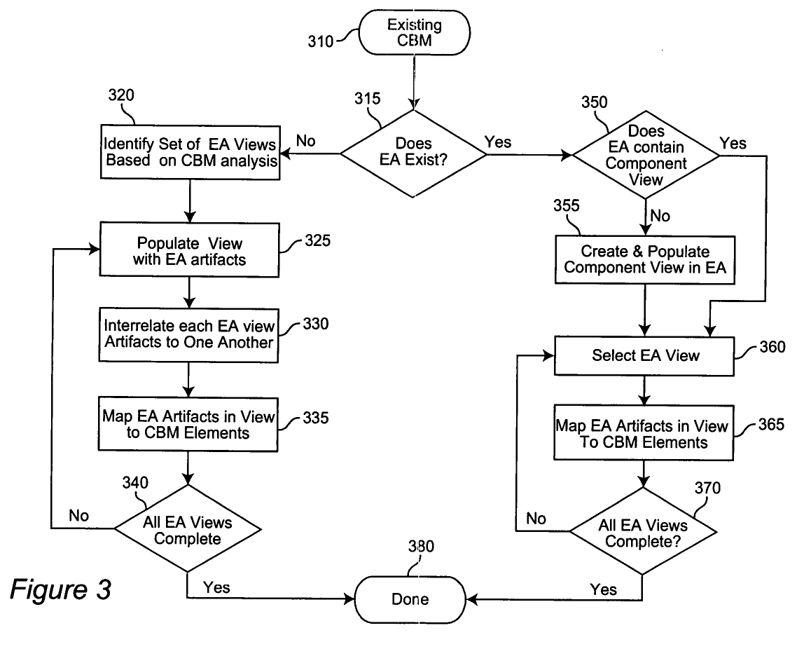

Turning now to FIG. 3 there is shown a flowchart for supporting enterprise architecture with a component business model. It is presumed that a component business model exists 310, that is, a component business model has been created for the business. The process splits into two paths, depending on whether 315 an enterprise architecture has been constructed for the business. If an EA already exists, a component view must be created and populated 355 if the component view is not already contained 350 within the EA. Then 360 an EA view (e.g. 150 in FIG. 1) is selected and the EA artifacts in the view are mapped 365 to CBM elements (e.g. a component or competency). This is repeated until all EA views have been completed 370. At that point the process is done 380. This method is also used to verify an existing enterprise architecture.

If and EA has not been created for the business, the CBM analysis provides a basis for identifying a set of EA views 320. Each view is populated 325 with EA artifacts, and the artifacts in a view are connected 330 to one another. Then the EA artifacts in the view are mapped 335 to CBM elements. This is repeated 340 until the process is complete 340 for all EA views, thereby completing the process 380.

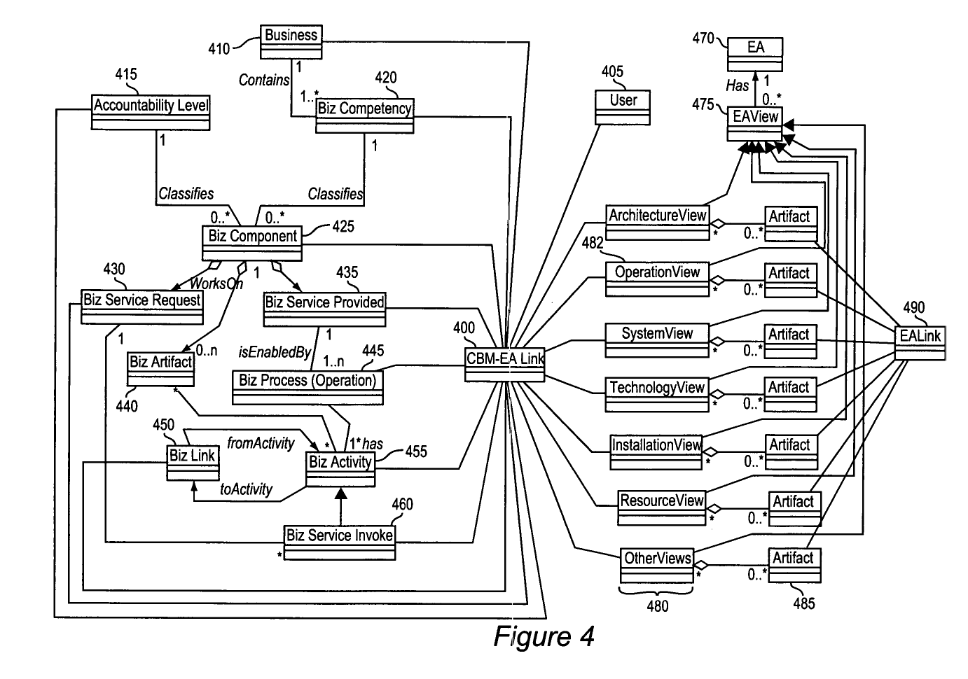

The integration of an enterprise architecture with a component business model is accomplished using a metamodel as shown in FIG. 4. The information constituting the enterprise architecture 470 is organized into views 475 for display in a number of particular views (e.g. 480, showing a non-exclusive list including an architecture view, an operation view, a systems view, a technology view, an installation view, and a resource view), each view having artifacts (e.g. 485) characteristic of the view, with both views and artifacts being supported by a common link 490. The information in the component business model constituting the business 410 is organized into components 425 arrayed by competency 420 and operational management (or management accountability) level 415. Each component 425 relies upon services requested 430 (and then invoked 460) and in turn provides services for use by other components. A link 450 is provided both to and from a business activity 455 triggered by a service request. The business activity 455 supports a business process 445 and a business artifact 440 (which serves as a record of the transaction and the results of the business process 445). The business 410 and EA 470 elements are connected by a CBM-EA link 400 and enables the mapping between CBM elements and the enterprise architecture. A user role 405 (e.g. business analyst 125 in FIG. 1) uses an element of the CBM framework (e.g. component 130 within CBM map 110 in FIG. 1) to qualify the type and amount of data supplied through the views 480 of the enterprise architecture, as well as to qualify the action the user is entitled to perform. It should be noted that any of the elements of the CBM framework as represented in the metamodel (component, competency, level, service, process, etc.) can be used to filter the data presented in an enterprise architecture view.

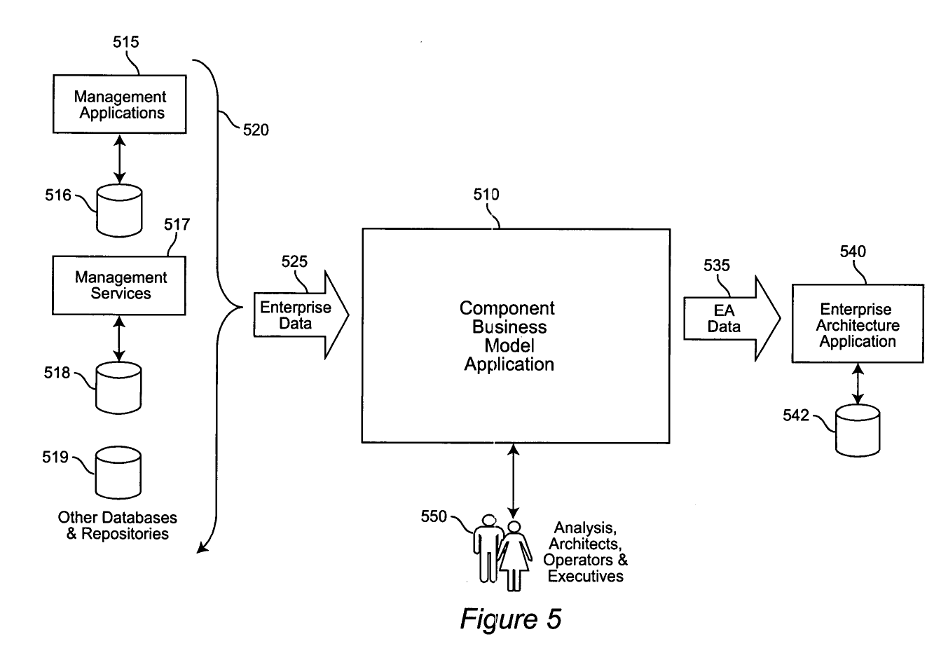

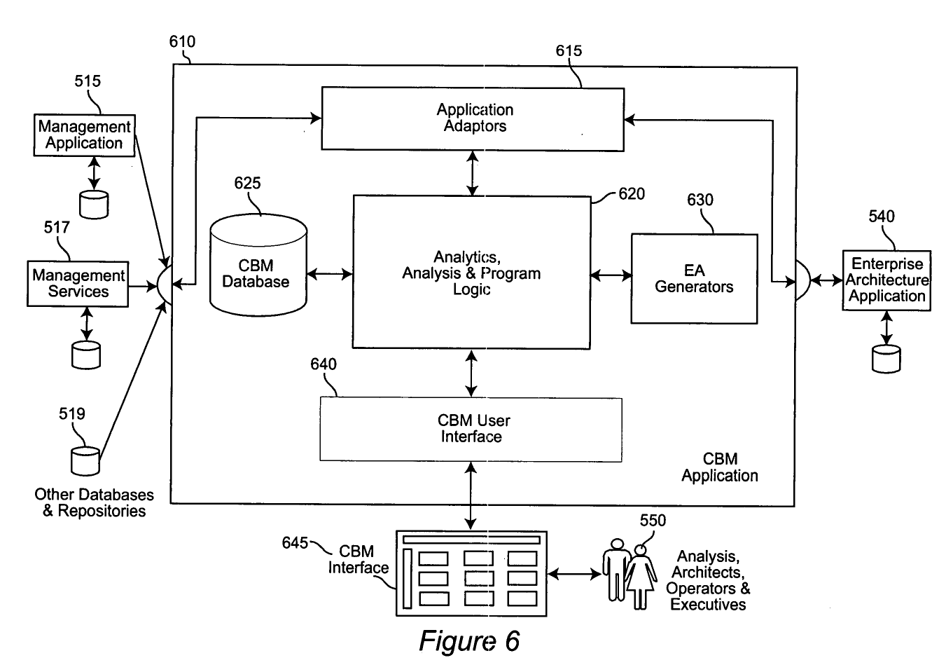

FIGS. 5 and 6 show how the component business model application 510 can be used to generate data for the enterprise architecture application 540. The business is supported by management applications 515 and their databases 516, management services 517 and their databases 518, and other databases and repositories 519. These all form 520 enterprise data 525 that is mapped to the component business model using the component business model application 510. Those (e.g. architects, operators and executives 550) responsible for creating the enterprise architecture then are able to use the component business model application 510 to generate EA data 535 for enterprise architecture application 540 and its database 542. For example, enterprise data 525 may contain information about business processes (item 445 in FIG. 4) which may be expressed as part of the OperationView 482.

The architecture supporting generation of data 535 for the enterprise architecture application 540 is shown in FIG. 6. Enterprise data from management applications 515, management services 517 and other databases and repositories 519 is routed within component business model application 610 to application adaptors 615. Program logic 620, in response to input and controls from EA architects 550 exercised via a CBM interface display 645, operating as a client on the machine of the user 550, and a CBM user interface driver 640, operating on the server within the CBM application, uses data in the CBM database 625, in conjunction with EA generators 630, to modulate application adaptors 615 to generate EA data (see FIG. 5, item 535) for the enterprise architecture application 540. The CBM interface 645 provides a graphic display of enterprise architecture, mapped to the CBM organizing model, to the machine of the user 550.

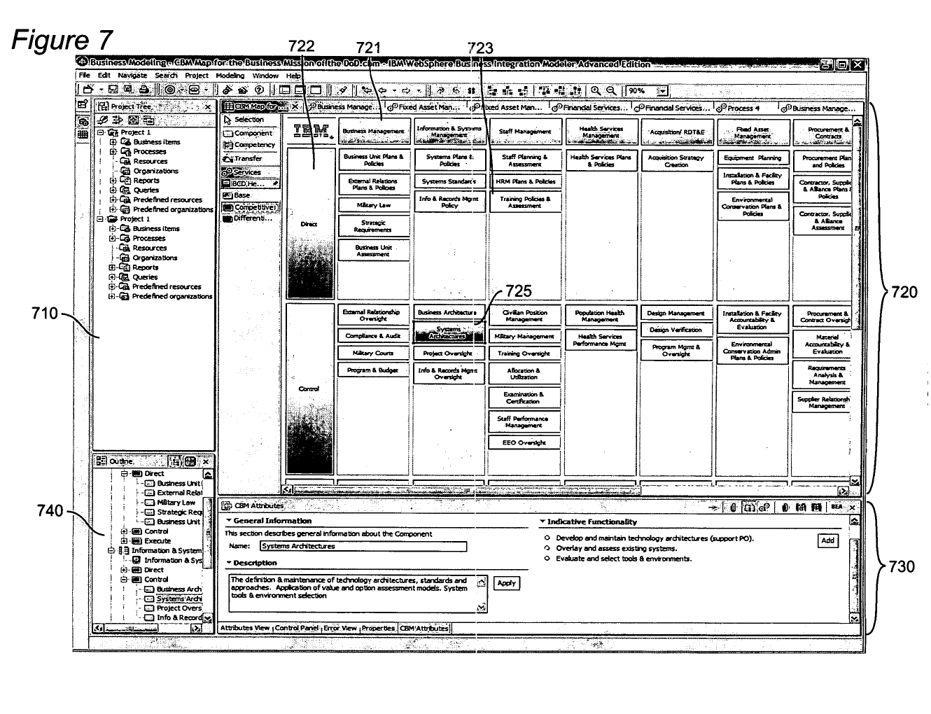

An example of the CBM interface display 645 is shown in the interface mockup of FIG. 7. Pane 710 shows a directory structure of a project tree. A CBM map of the enterprise selected in pane 710 is shown in pane 720, comprising columns of competencies (e.g. 721) and management level rows (e.g. 722) within which are arrayed components (e.g. 723). For the highlighted component (e.g. systems architecture component 725) pane 730 shows the CBM attributes of the component. Pane 740 shows an outline of CBM information associated with the CBM map shown in pane 720. It is the selection of the component selected in pane 720 that drives the content of pane 730.

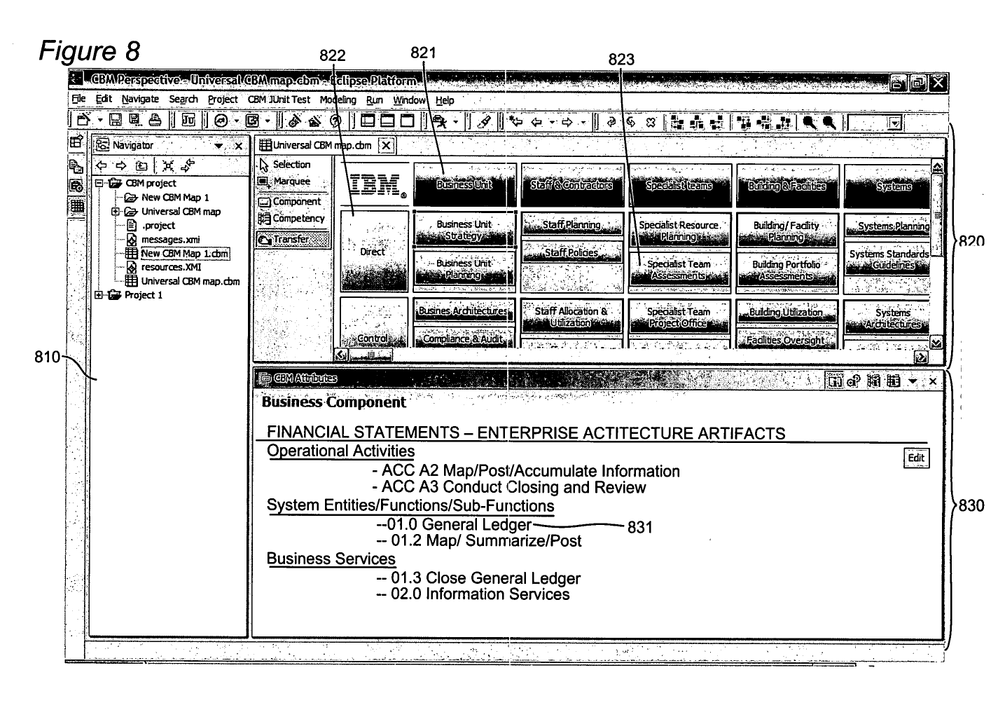

Another example of the CBM interface display is shown in the interface mockup of FIG. 8. Pane 810 shows a directory structure associated with a CBM project. A CBM map of the enterprise is shown in pane 820, comprising columns of competencies (e.g. 821), management level rows (e.g. 822) within which are arrayed components (e.g. 823). For the highlighted component in pane 820 (e.g. financial statements component, contained on a portion of the Universal CBM map hidden from view in pane 820 of FIG. 8), pane 830 shows the enterprise architecture artifacts that have been mapped to the component (e.g. general ledger artifact 831). The content of pane 830 for the component selected in pane 820 is driven by the mapping of CBM elements and enterprise architecture views (and their artifacts) as described in the CBM-EA link item 400 shown in FIG. 4, as qualified by the user's role (as shown by item 405 in FIG. 4). Generation of display information is performed by the Analytics, Analysis and Program Logic 620 and the CBM User Interface driver 640 illustrated in FIG. 6.

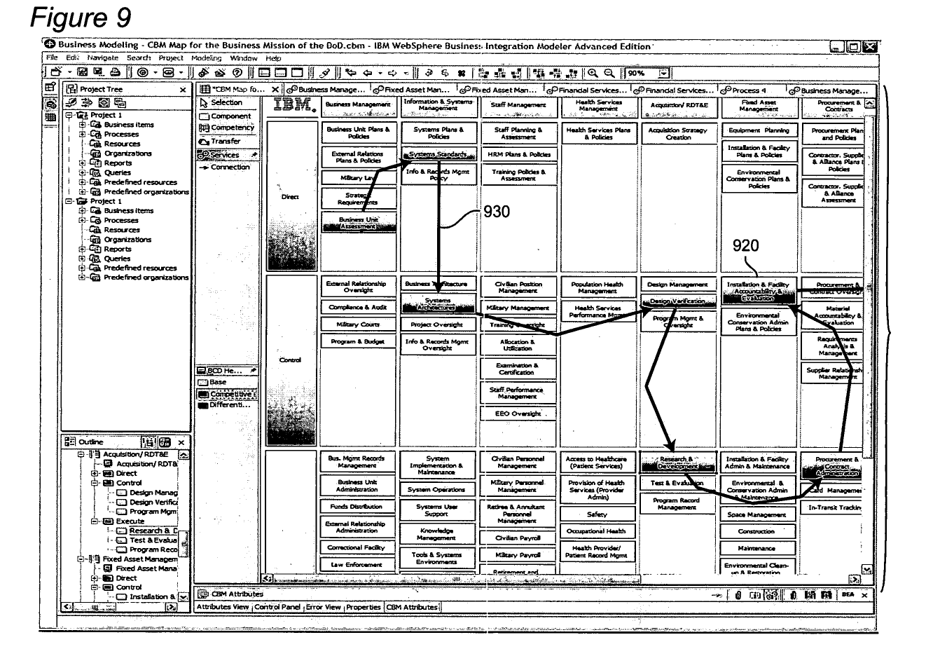

A further interface mockup of an implementation of the invention is shown in FIG. 9. Within a pane 910 containing a CBM map of a business there is overlaid a representation of a business process selected from the enterprise architecture. The overlay representation presented in FIG. 9 consists of two features. First, the components involved in the process are highlighted (e.g. item 920). Second, the connections between components are shown by lines (e.g. item 930). To support the process, information goes across the line, and details pertaining to this information flow can be displayed by selecting the line. For example, an artifact of the enterprise architecture may specify a business artifact to be exchanged between components or a TCP/IP standard for the communications links represented by the lines.

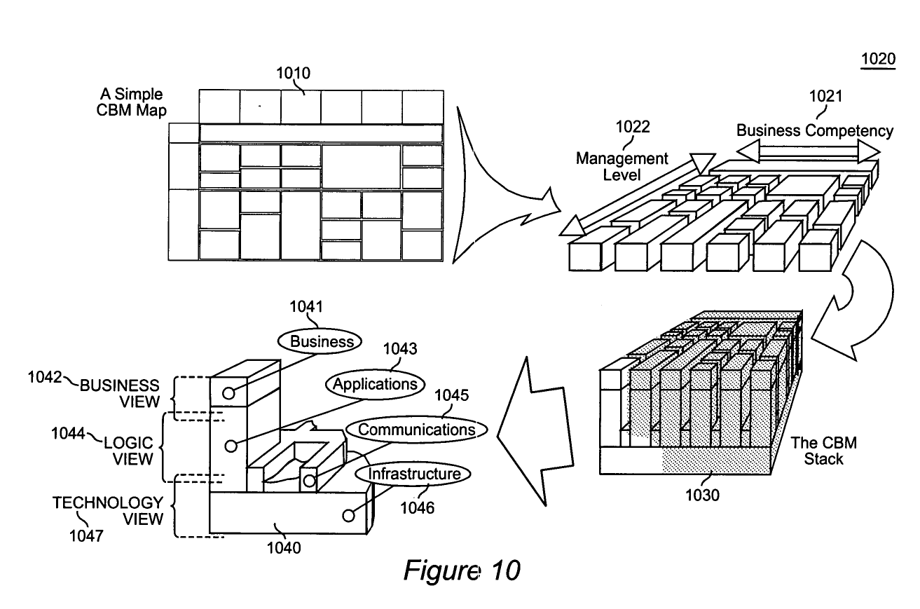

The business architecture, application architecture and technology architecture of the enterprise are part of the CBM stack 1030, as shown in FIG. 10. The partitioning of the business represented by the CBM map provides a versatile index that applies consistently through all the underlying layers from which a solution for the business is constructed. A simple CBM map 1010 represented as a matrix 1020 of components or aggregates of components, arrayed by business competency 1021 and management level 1022, serves as the business layer 1041 representing a business view 1042 of a multi-layered CBM stack 1030. The same component structure flows down through the applications 1043 which represent the computer implemented logic (application view) 1044 of the business, connected by a communications layer 1045, and built upon a technology infrastructure 1046 representing a technology view 1047 of the business.

These layers of the CBM stack implicitly correspond to views of the enterprise architecture. In particular, the EA artifacts comprising the business architecture support a “business view” 1042 within the EA. The EA artifacts comprising the applications architecture support an “applications view” within the EA. Similarly, there are EA artifacts associated with the communications layer 1045 and which support a “communications view” within the EA. Finally, the technology infrastructure 1046 of the business is enabled by artifacts that comprise a “technology view” 1047 of the business. Consequently, the invention is based not simply upon a mapping of enterprise architecture artifacts to a CBM map but upon a deeper coupling—keyed to the CBM partitioning—to the layers of the CBM stack. This coupling works in both directions. The EA user uses CBM as an index, and the CBM user uses the various views of EA, and the architectures associated with the CBM stack, as part of the CBM analysis. For example, the rules and policies for defining CBM elements can themselves be artifacts in the business architecture associated with the business layer of the CBM stack.

While the invention has been described in terms of preferred embodiments, those skilled in the art will recognize that the invention can be practiced with modification within the spirit and scope of the appended claims.

Having thus described our invention, what we claim as new and desire to secure by Letters Patent is as follows:

1. A method for representing an enterprise architecture comprising:
identifying at least one enterprise architecture view in a component business model of an organization;
for each said view, identifying at least one enterprise architecture artifact in the view and mapping each identified artifact to a corresponding element of the component business model.

2. A method as in claim 1, wherein said identifying further comprises creating a component view in an existing enterprise architecture.

3. A method as in claim 1, wherein said identifying further comprises using a component business model analysis to identify and generate said at least one enterprise architecture view.

4. A method as in claim 1, wherein said enterprise architecture views include a view coupled to a layer of a component business model stack.

5. A method as in claim 4, wherein said coupled view is one of a group consisting of i) a business view coupled to a business layer in the component business model stack, ii) an application view coupled to an application layer in the component business model stack, and iii) a technology view coupled to a technology layer in the component business model stack.

6. A method as in claim 1, further comprising verifying said enterprise architecture using said component business model.

7. A method as in claim 1, wherein an enterprise architecture view presented to a user is filtered by a selected element of the component business model.

8. A method as in claim 7, wherein said selected element is one of a group consisting of a component, a competency, a management accountability level, a business service, and a business process.

9. A method as in claim 1, wherein each said enterprise architecture view is one of a group consisting of an architecture view, an operation view, a system view, a technology view, a business view, an application view, an installation view and a resource view.

10. A method as in claim 7, wherein an enterprise architecture view presented to a user is also filtered by a role of said user.

11. An enterprise architecture representation comprising:
a component business model having enterprise architecture views populated with enterprise architecture artifacts;
an enterprise architecture having a component view, said artifacts being mapped to corresponding elements in said component business model.

12. An enterprise architecture representation as in claim 11, wherein said enterprise architecture views include a view coupled to a layer of a component business model stack.

13. An enterprise architecture representation as in claim 12, wherein said coupled view is a technology view coupled to a technology layer in the component business model stack.

14. An enterprise architecture representation as in claim 11, wherein said enterprise architecture is verified using said component business model.

15. An enterprise architecture representation as in claim 11, wherein an enterprise architecture view presented to a user is filtered by a selected element of the component business model.

16. An enterprise architecture representation as in claim 15, wherein said selected element of the component business model is one of a group consisting of a component, a competency, a management accountability level, a business service, and a business process.

17. An enterprise architecture as in claim 11, wherein each said enterprise architecture view is one of a group consisting of an architecture view, an operation view, a system view, a technology view, a business view, an application view, an installation view and a resource view.

18. An enterprise architecture as in claim 15, wherein an enterprise architecture view presented to a user is also filtered by a role of said user.

19. Implementing a service for representing an enterprise architecture, comprising the method of:
identifying at least one enterprise architecture view in a component business model of an organization;
for each said view, identifying at least one enterprise architecture artifact in the view and mapping each identified artifact to a corresponding element of the component business model.

20. A method implementing a service as in claim 19, wherein said identifying further comprises creating a component view in an existing enterprise architecture.

21. A method implementing a service as in claim 19, wherein said identifying further comprises using a component business model analysis to identify and generate said at least one enterprise architecture view.

22. A computer implemented system for representing an enterprise architecture comprising:
first computer code for identifying at least one enterprise architecture view in a component business model of an organization;
second computer code for identifying at least one enterprise architecture artifact in each said view and mapping each identified artifact to a corresponding element of the component business model.

23. A computer implemented system as in claim 22, wherein said first computer code for identifying further comprises third computer code for creating a component view in an existing enterprise architecture.

24. A computer implemented system as in claim 22, wherein said first computer code for identifying further comprises fourth computer code using a component business model analysis to identify and generate said at least one enterprise architecture view.
